(19) United States
(12) Patent Application Publication
(10) Pub. No.: US 2024/0243934 A1
(43) Pub. Date: Jul. 18, 2024

(54) BLOCKCHAIN, METHOD FOR TRANSMITTING INFORMATION BETWEEN NODES OF THE BLOCKCHAIN, AND METHODS FOR CONFIGURING AND QUERING THE BLOCKCHAIN

(71) Applicant: WRT Technologies Limited, London (GB)

(72) Inventors: Luc MOREAU, London (GB); Dong TRUNGH, London (GB); Tim DISNEY, London (GB); Nick ROBINSON, London (GB); Stephen HILL, London (GB)

(73) Assignee: WRT Technologies Limited, London (GB)

(21) Appl. No.: 18/563,894

(22) PCT Filed: May 24, 2022
(86) PCT No.: PCT/GB2022/051304

§ 371 Date: Nov. 23, 2023

(30) Foreign Application Priority Data
May 24, 2021 (GB) 2107384.6

(51) Int. Cl. H04L 9/00; G06Q 10/06; G06Q 10/087; G06Q 20/06

(52) U.S. Cl. CPC H04L 9/50; G06Q 10/06; G06Q 10/087; G06Q 20/0655

(57) ABSTRACT

There is described a method of transmitting information from a first node of a blockchain to a second node of the blockchain, the method being carried out by the first node and comprising: receiving a transaction referencing an object and a containing set of the blockchain; determining an existing instance of each of the object and the containing set; updating the existing instance of each of the object and the containing set; and transmitting to the second node of the blockchain the updated instance of each of the object and the containing set. The blockchain may be used to record and/or query provenance information.

### FIELD OF INVENTION

The present invention relates to a blockchain as well as to methods of transmitting information between nodes of the blockchain, methods of configuring the blockchain, and methods of querying the blockchain.

### BACKGROUND

Existing methods and systems for performing transactions typically involve the transfer of fiat currency between two parties in exchange for a good or service. Once the transaction has been completed, there is little to no record of the transaction and its context and the currency can thereafter be used freely. It is difficult to determine whether a transaction involves an undesirable element, such as a corrupt party or a fraudulent document, and even if an undesirable element is identified, it can be difficult to retrieve evidence of the details of the transaction.

### SUMMARY

Aspects and embodiments of the present invention are set out in the appended claims. These and other aspects and embodiments of the invention are also described herein.

According to least one aspect of the present disclosure, there is described a computer-implemented method of transmitting information from a first node of a blockchain to a second node of the blockchain, the method being carried out by the first node and comprising: receiving a transaction referencing an object and a first containing set of the blockchain; determining an existing instance of each of the object and the first containing set; updating the existing instance of each of the object and the first containing set; and transmitting to the second node of the blockchain the updated instance of each of the object and the first containing set.

Preferably, the method comprises validating the transaction and/or propagating the transaction through the nodes of the blockchain. Preferably, the method comprises associating the updated instances with the transaction before and/or after validation and/or propagation of the transaction.

Preferably, the transaction referencing the object comprises the transaction referencing an identifier of the object. Preferably, the transaction referencing the object comprises the transaction referencing a persistent identifier.

Preferably, the transaction comprises a transaction between a first party and a second party.

Preferably, the method comprises: identifying a second containing set of the blockchain; updating an existing instance of each of the first containing set, the second containing set, and the object; and transmitting to the second node of the blockchain the instance of each of the first containing set, the second containing set, and the object. Preferably, the first containing set is associated with a/the first party and/or the second containing set is associated with a/the second party.

Preferably, updating an instance comprises incrementing the instance.

Preferably, the object, the first containing set, and a/the second containing set are each associated with a persistent identifier that is recorded on the blockchain.

Preferably, the transaction referencing the object comprises the transaction referencing a persistent identifier of the object.

Preferably, the transaction referencing the first containing set comprises the transaction referencing a persistent identifier of the first containing set

Preferably, the object, the first containing set, and a/the second containing set are each associated with an ephemeral identifier that is recorded on the blockchain.

Preferably, the transaction referencing the object comprises the transaction referencing an ephemeral identifier of the object.

Preferably, the method comprises determining an existing instance of one or more of: the object, the first containing set, and a/the second containing set.

Preferably, determining the existing instance comprises determining the existing instance from a record stored on the blockchain, preferably from an ephemeral identifier stored on the blockchain.

Preferably, determining the existing instance comprises determining a most recent instance associated with a/the persistent identifier.

According to an aspect of the present disclosure, there is described a computer-implemented method of transmitting information from a first node of a blockchain to a second node of the blockchain, the method being carried out by the first node and comprising: receiving a transaction referencing an object and a first containing set of the blockchain; determining an existing instance of each of the object and the first containing set; updating the existing instance of each of the first containing set and the object; and transmitting to the second node of the blockchain the updated instance of each of the object and the first containing set; wherein: the object and the first containing set are each associated with a persistent identifier that is recorded on the blockchain; and determining the existing instance comprises determining a most recent instance associated with the persistent identifier from a record stored on the blockchain.

Preferably, the method comprises transmitting to the second node two or more of: a persistent identifier relating to the object and/or the first containing set; an ephemeral identifier relating to the object and/or the first containing set; an ephemeral identifier relating to the object and/or the first containing set before completion and/or recording of the transaction; an ephemeral identifier relating to the object and/or the first containing set after completion and/or recording of the transaction;

### Transaction/Object/Containing-Set Types

Preferably, the transaction is associated with one or more of the transaction types: a transfer of the object between containing sets; a transformation of the object; a transformation of the object with the object remaining in the same containing set; a change of state of the object; a creation of the object; a destruction of the object; a splitting of the object; and a joining of a plurality of objects.

Preferably, the method comprises determining that the object is a new object. Preferably, the method comprises creating an initial instance and/or identifier for the new object. Preferably, updating the instance comprises creating an initial instance and/or identifier.

Preferably, the method comprises determining that the containing set is a new containing set. Preferably, the method comprises creating an initial instance and/or identifier for the new containing set. Preferably, updating the instance comprises creating an initial instance and/or identifier for the containing set.

Preferably, the method comprises determining that the transaction relates to the destruction of the object.

Preferably, the method comprises removing the object from the first containing set.

Preferably, the object comprises a coin. Preferably, the first containing set and/or a/the second containing set comprises a wallet. Preferably, the method comprises: transferring the coin from a first wallet associated with the first party to a second wallet associated with a/the second party; or transferring the coin from the second wallet to the first wallet.

Preferably, the object comprises a document. Preferably, the first containing set and/or the second containing set comprises a document pool. Preferably, the method comprises: transferring the document from a first document pool associated with the first party to a second document pool associated with a/the second party; or transferring the document from the second document pool to the first document pool.

Preferably, the object comprises a good. Preferably, the first containing set and/or a/the second containing set comprises an inventory. Preferably, the method comprises: transferring a good from a first inventory associated with the first party to a second inventory associated with a/the second party; or transferring the good from the second inventory to the first inventory.

Preferably, the object comprises a person. Preferably, the first containing set and/or the second containing set comprises a team. Preferably, the method comprises: transferring a person from a first team associated with the first party to a second team associated with a/the second party; or transferring the person from the second team to the first team.

Preferably, the method comprises identifying a further object, wherein the transaction is dependent on, and/or references, both the object and the further object.

Preferably, the object and the further object comprise different types of objects. Preferably, the object comprises a coin and the further object comprises a document and/or good.

Preferably, the method comprises determining a third containing set associated with the further object and the first party.

Preferably, the method comprises identifying a fourth containing set associated with the second party.

### Shared Addresses for Containing Sets

Preferably, the first containing set and the third containing set are associated with the same blockchain address and/or cryptographic key.

According to an aspect of the present disclosure, there is described a computer-implemented method of transmitting information from a first node of a blockchain to a second node of the blockchain, the method being carried out by the first node and comprising: receiving a transaction referencing an object and a further object of the blockchain; identifying a first containing set of the blockchain associated with the object; identifying a further containing set of the blockchain associated with the further object; wherein the first containing set and the further containing set are associated with the same blockchain address and/or cryptographic key; and transmitting information to the second node of the blockchain in dependence on the transaction.

Preferably, the method comprises determining a plurality of containing sets associated with the first party, wherein each of the containing sets is associated with the same blockchain address and/or cryptographic key. Preferably, the method comprises comprising determining at least three containing sets, at least five containing sets, at least ten containing sets, and/or at least twenty containing sets.

### Object/Containing Set Interdependencies

Preferably, each of the plurality of containing sets comprises a different type of containing set.

Preferably, the method comprises identifying a plurality of objects associated with a/the transaction, the plurality of objects comprising at least two of the object types: a coin; a document; and a good.

Preferably, the method comprises identifying a plurality of objects associated with a/the transaction, the plurality of objects comprising at least two of the object types: a coin; a document; a person; and a good.

Preferably, the method comprises identifying a plurality of containing sets associated with a/the transaction, the plurality of containing sets comprising at least two of the containing sets types: a wallet; a document pool; a team; and an inventory.

Preferably, the method comprises determining an interdependency between a plurality of objects of different object types and/or a plurality of containing sets of different types. Preferably, the method comprises comprising validating a/the transaction based on an interdependence between plurality of objects and/or containing sets associated with the transaction.

Preferably, the method comprises transmitting the interdependency to the second node.

According to another aspect of the present disclosure, there is described a computer-implemented method of transmitting information from a first node of a blockchain to a second node of the blockchain, the method being carried out by the first node and comprising: receiving a transaction referencing a plurality of objects of the blockchain; the plurality of objects comprising at least two of the object types: a coin; a document; and a good; determining an interdependency between a plurality of objects of different object types; and transmitting the interdependency to the second node of the blockchain.

According to another aspect of the present disclosure, there is described a computer-implemented method of transmitting information from a first node of a blockchain to a second node of the blockchain, the method being carried out by the first node and comprising: receiving a transaction referencing a plurality of containing sets of the blockchain; the plurality of containing sets comprising at least two of the containing set types: a wallet; a document pool; and an inventory; determining an interdependency between a plurality of containing sets of different containing set types; and transmitting the interdependency to the second node of the blockchain.

Preferably, the transaction references at least one object of each of the object types and/or containing set types.

Preferably, each different type of object is associated with a different type of containing set.

Preferably, the method comprises determining provenance information associated with the transaction.

Preferably, the provenance information is determined based on one or more of: the first party and/or the second party; an input from the first party and/or the second party; a type of the good; and a similarity to a previous transaction.

Preferably, the method comprises associating the provenance information with one or more of: the object, the first containing set, and/or a/the second containing set.

Preferably, the provenance information comprises one or more of: a reason for the transaction; an assessment of a/the sender and/or a/the recipient, such as an indication of a trust level; and information added by a third party following the transaction.

Preferably, the method comprises receiving a confirmation from a third party, the confirmation being associated with the provenance information. Preferably, the confirmation verifies and/or provides the provenance information. Preferably, the method comprises validating and/or propagating a transaction in dependence on the confirmation.

### Provenance Storage and Querying

Preferably, the method comprises determining provenance information associated with a plurality of blocks of the blockchain. Preferably, the method comprises determining the provenance information based on a query.

Preferably, determining provenance information comprises determining a plurality of transactions associated with the same provenance identifier and/or transaction identifier.

Preferably, determining provenance information for an object comprises determining a dependency between the object and a further object.

Preferably, the method comprises determining a transaction identifier to be associated with the transaction and/or with provenance information relating to the transaction, and transmitting the transaction identifier to the second node.

Preferably, the method comprises identifying a plurality of related transactions. Preferably, the method comprises identifying a plurality of related transactions in a block, wherein determining the transaction identifier comprises determining a transaction identifier that is the same for each related transaction.

Preferably, the method comprises determining a transaction type and/or a transaction identifier and transmitting the transaction type and/or the transaction identifier to the second node.

Preferably, the method comprises persisting and/or indexing a record comprising a transaction type and/or a transactions identifier and the updated instance of each of the object and the first containing set,

According to an aspect of the present disclosure, there is described a computer-implemented method of transmitting information from a first node of a blockchain to a second node of the blockchain, the method being carried out by the first node and comprising: receiving a transaction referencing an object and a first containing set of the blockchain; identifying an existing instance of each of the object and the first containing set; updating the existing instance of each of the object and the first containing set; indexing a record comprising a transaction type, a transaction identifier, and the updated instance of each of the object and the first containing set; and transmitting to the second node of the blockchain the updated instance of each of the object and the first containing set.

Preferably, the method comprises indexing a plurality of records, each record relating to a different transaction. Preferably, the transaction identifier for each record is the same so as to indicate the transactions are related.

Preferably, the method comprises indexing a plurality of records relating to the transaction. Preferably, the transaction identifier for each record is the same so as to indicate the records are each related to the transaction.

Preferably, the record comprises one or more identifier(s) associated with one or more of: the object, the first containing set, and/or the transaction.

### Score

Preferably, the method comprises determining a score associated with the object and/or the first containing set.

Preferably, the score is dependent on one or more of: a dependency and/or association of the object and/or the first containing set; and provenance information associated with the object and/or the first containing set.

Preferably, the method comprises outputting the score and/or providing an alert if the score is below a threshold score.

Preferably, determining the score comprises determining a plurality of related transactions and/or records, preferably based on a shared transaction identifier, wherein the score is dependent on each of these transactions and/or records.

### Ordering (GS1)

Preferably, the method comprises determining a plurality of instances of the object recorded on the blockchain, and determining an order of the instances, preferably wherein the order is dependent on the transactions in which the object has been referenced.

Preferably, the method comprises transmitting export data to a node of the blockchain, which export data relates to the object and comprises an indication of the earlier instance. Preferably, transmitting export data comprises transmitting export data in a format of the GS1 standard (e.g. a GS1 EPCIS event) and/or a/the W3C PROV recommendations. Preferably, transmitting export data comprises transmitting an instance order associated with each of the instances of the object.

Preferably, the method comprises transmitting import data to a node of the blockchain, which import data relates to the object and comprises an indication of the earlier instance. Preferably, transmitting import data comprises transmitting import data in a format of the GS1 standard (e.g. based on a GS1 EPCIS event). Preferably, transmitting import data comprises transmitting an instance order associated with each of the instances of the object.

Preferably, the export data and/or the import data comprises: an identifier of an object; an identifier of a containing set; and/or a relationship between the identifier and the containing set.

Preferably, the method comprises combining information from a plurality of blocks of the blockchain to form the data. Preferably, the method comprises the combining of the information is dependent on the order of the instances.

According to another aspect of the present disclosure, there is described a computer-implemented method of transmitting data from a first node of a blockchain to a second node of the blockchain, the method being carried out by the first node and comprising: receiving a request relating to an object recorded on the blockchain; determining a plurality of instances of the object recorded on the blockchain, determining an order of the instances; combining information from a plurality of blocks of the blockchain to form export data, the export data relating to the object and comprises an indication of the earlier instance; and transmitting the export data to the second node of the blockchain; wherein the combining of the information is dependent on the order of the instances.

Preferably, determining the order comprises determining a dependency between the object and a further object on the blockchain, and determining the order based on the dependency.

Preferably, receiving the transaction comprises receiving a GS1 EPCIS event.

### Interpreter Versions

Preferably, the method comprises: determining a version of an interpreter associated with the blockchain at the time of receipt of the transaction, the interpreter preferably being an interpreter for records comprising a transaction type, a transaction identifier, and an instance; and transmitting an indicator of the version to the second node.

According to an aspect of the present disclosure, there is described a computer-implemented method of transmitting data from a first node of a blockchain to a second node of the blockchain, the method being carried out by the first node and comprising: receiving a transaction referencing an object and a further object of the blockchain; determining a version of an interpreter associated with the blockchain at the time of receipt of the transaction, the interpreter preferably being an interpreter for records comprising a transaction type, a transaction identifier, and an instance; and transmitting an indicator of the version to the second node.

Preferably, transmitting the instance comprises one or more of: transmitting a transaction including the instance; including the instance in a block to the blockchain; proposing a block for addition to the blockchain, the block including the instance; associating the instance with a transaction of the blockchain and validating the transaction; transmitting a block including the instance to the second node of the blockchain; confirming that the transaction has been completed and/or validated; and outputting the instance to a user of the second node.

According to another aspect of the present disclosure, there is described a computer-implemented method of transmitting information from a third node of a blockchain to a fourth node of the blockchain, the method being carried out by the third node and comprising: receiving a query referencing one or more of: a transaction, an object, a containing set, a block, an object attribute, or set of them, or a time interval, and a block range; determining one or more records on the blockchain matching the query; and transmitting the records to the third node.

Preferably, the query comprises one or more of: a transaction identifier; an object identifier; a containing set identifier; a time period; and a block range.

Preferably, the method comprises determining a version of an interpreter. Preferably, determining the versions comprises determining a version indicator, wherein the transmitting the records is dependent on the version of an interpreter associated with the records.

Preferably, the method comprises determining a version of an interpreter for each of the records.

Preferably, the third node comprises the first node and the fourth node comprises the second node.

### Blockchain

According to another aspect of the present disclosure, there is described a blockchain comprising a transaction associated with an object and a first party, the transaction being associated with: a first containing set associated with the first party; and wherein the transaction is associated with an update in the instance of each of the object and the first containing set.

Preferably, each transaction is associated with an object.

Preferably, each transaction is associated with the updating of an instance of one or more objects referenced by the transactions, and/or one or more containing sets referenced by the transaction.

Preferably, each transaction of the blockchain is associated with provenance information.

Preferably, the blockchain comprises a plurality of objects, wherein each object is associated with a containing set. Preferably, each object is associated with a single containing set. Preferably, for each block of the blockchain, each object is associated with a single instance of the object.

Preferably, the blockchain comprises a plurality of coins, wherein each coin is associated with a wallet.

Preferably, each coin is associated with a single wallet.

Preferably, the blockchain comprises a plurality of documents, wherein each document is associated with a document pool. Preferably, each document is associated with a single document pool.

Preferably, the blockchain comprises a plurality of goods, wherein each good is associated with an inventory.

Preferably, for each block of the blockchain, each good is associated with a single inventory.

Preferably, one or more of the blocks of the blockchain comprises an indicator associated with an interpreter version, which indicator is arranged to indicate a device to be used for interpreting the information in said blocks.

Preferably, one or more of the blocks of the blockchain comprises an indicator associated with an interpreter version, a transaction identifier, and an instance, which indicator is arranged to indicate a device to be used for interpreting the information in said blocks.

Preferably, the interpreter comprises an interpreter for records comprising a transaction type.

Preferably, the blockchain comprises a plurality of blocks with differing indicators, the differing indicators being associated with different interpreter versions.

According to another aspect of the present disclosure, there is described a method of determining provenance information by querying a plurality of blocks of the aforesaid blockchain. Preferably, the method comprises querying provenance information associated with a plurality of transactions of the blockchain.

Preferably, the method comprises identifying similar provenance information associated with a plurality of transactions of the blockchain.

Preferably, the method comprises determining a plurality of instances of an object and/or a containing set, the plurality of instances being recorded on the blockchain.

Preferably, the method comprises determining a chronology of the object based on an order of the plurality of instances.

Preferably, the method comprises determining a score associated with an object, a containing set, a sender, and/or a recipient.

According to another aspect of the present disclosure, there is described an apparatus arranged to perform the aforesaid method.

According to another aspect of the present disclosure, there is described an apparatus arranged to store, access, view, and/or edit the aforesaid blockchain.

Preferably, the apparatus comprises a communication interface for communicating with a plurality of other nodes of the blockchain.

Preferably, the apparatus comprises a user interface for outputting to a user information recorded on the blockchain.

Preferably, the apparatus comprises a processor for identifying an indicator recorded in association with a block of the blockchain, the indicator relating to an interpreter version, wherein the processor is arranged to determine a device and/or program to be used for interpreting the information in said block based on the indicator.

The invention extends to any novel aspects or features described and/or illustrated herein.

Further features of the disclosure are characterised by the other independent and dependent claims.

Any feature in one aspect of the disclosure may be applied to other aspects of the disclosure, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform any of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

The disclosure extends to methods and/or apparatus substantially as herein described with reference to the accompanying drawings.

Aspects and embodiments of the disclosure will now be described, purely by way of example, with references to the accompanying drawings in which:

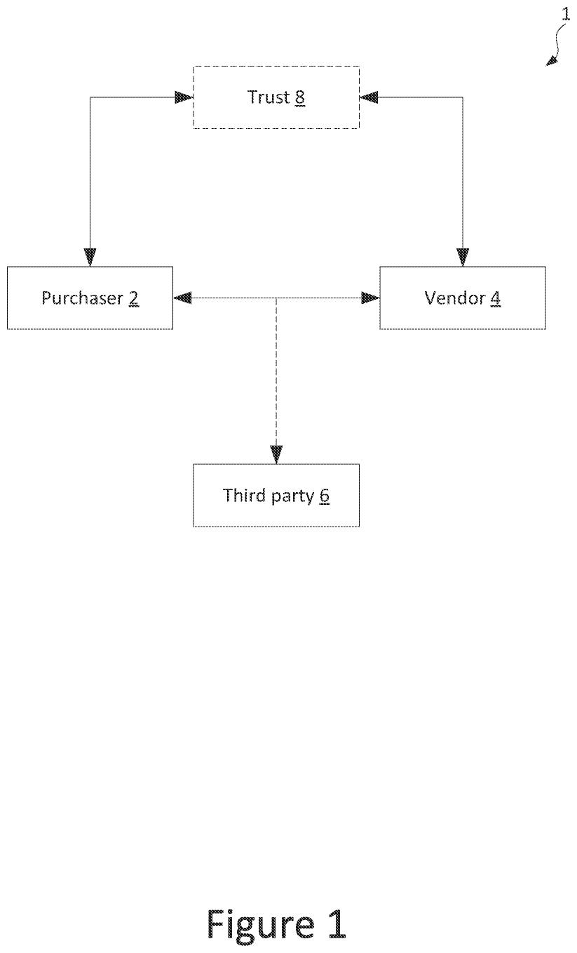

FIG. 1 shows a system in which two parties wish to make a transaction;

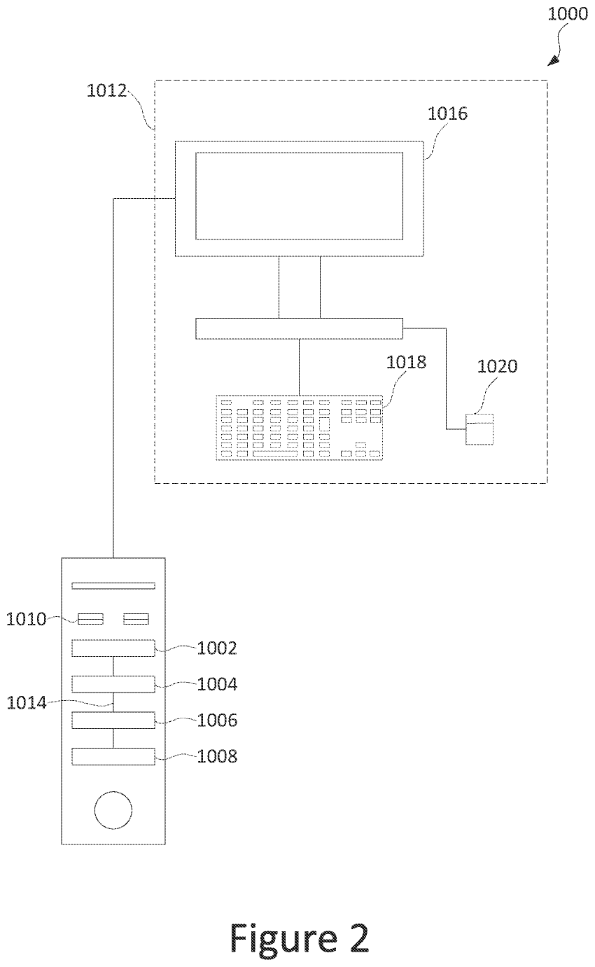

FIG. 2 illustrates a computer device on which aspects of the disclosed system are implemented;

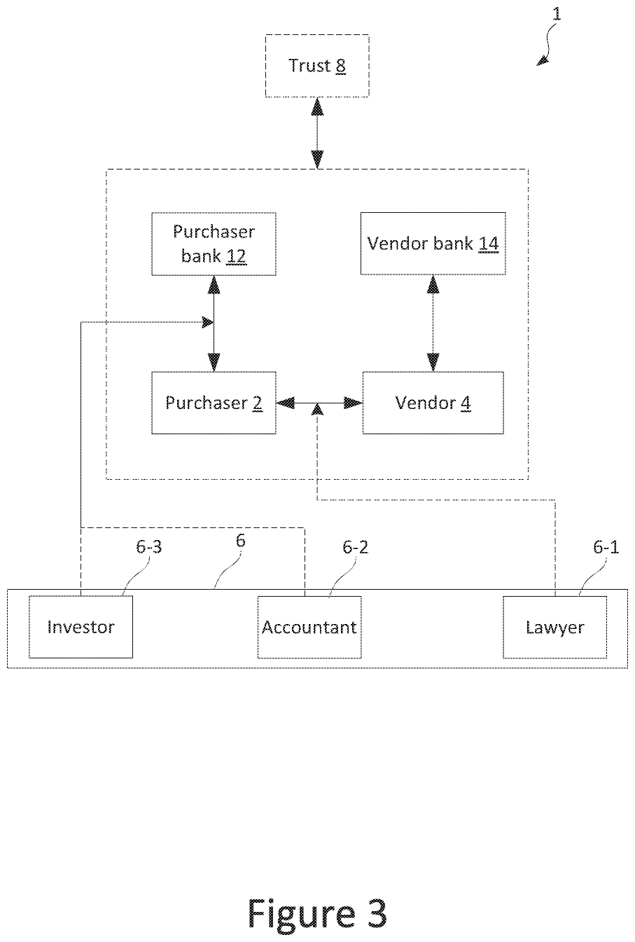

FIG. 3 shows a detailed embodiment of a system in which a purchaser and a vendor complete a transaction;

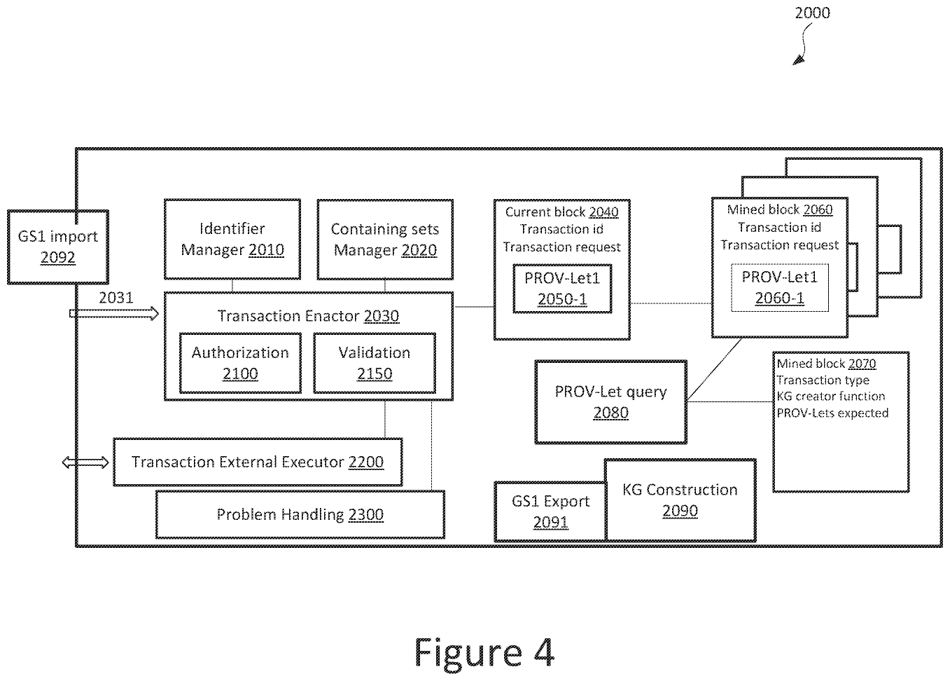

FIG. 4 shows a system comprising modules that may be implemented on a node of a blockchain;

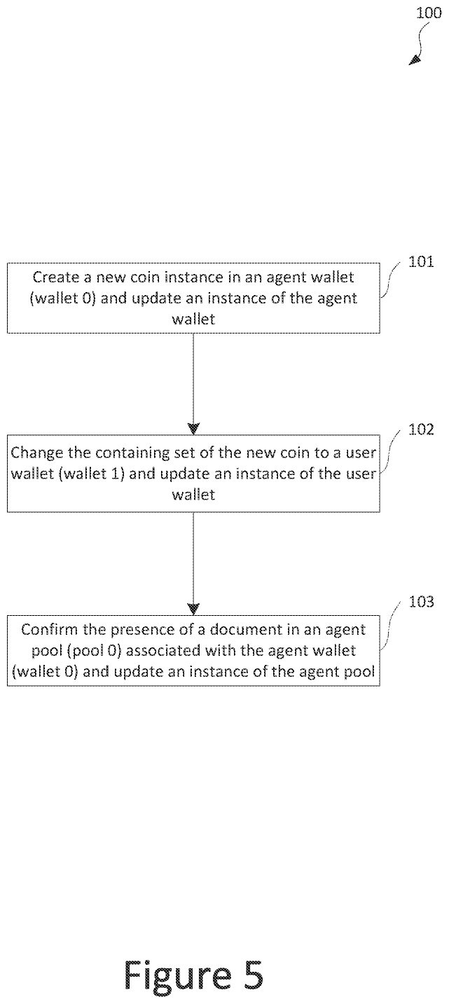

FIG. 5 shows a method of issuing a coin and transferring the coin to a wallet;

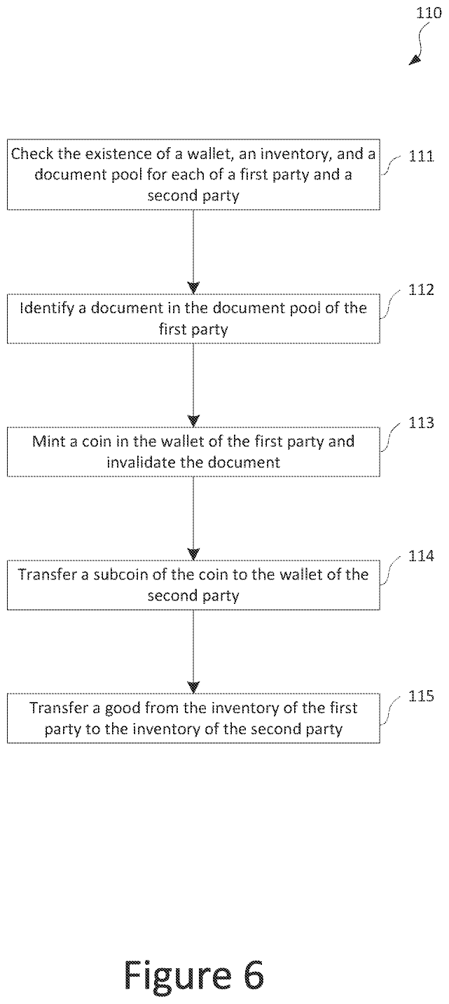

FIG. 6 shows a method of transferring a subcoin and a good based on documents; and

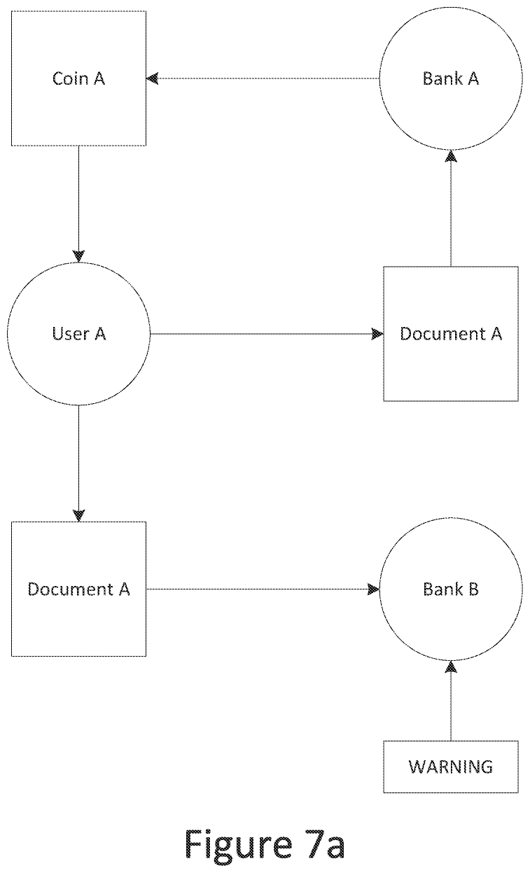

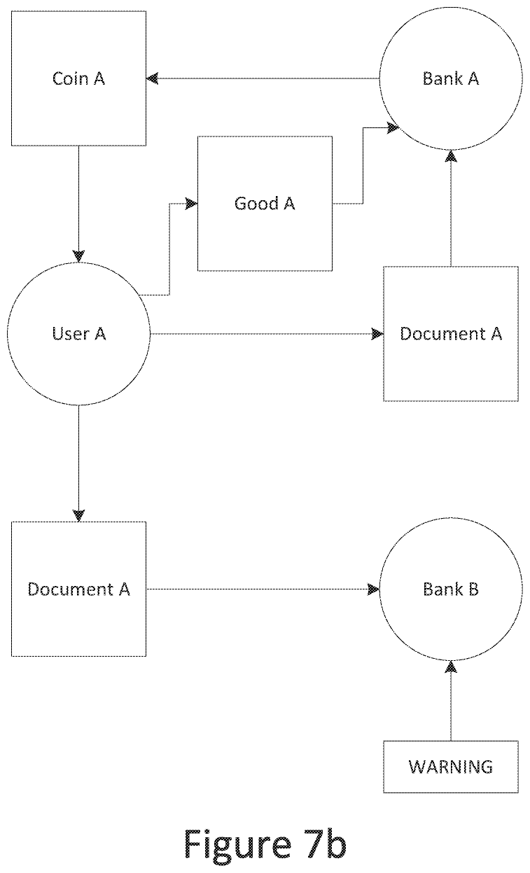

FIGS. 7a and 7b show the detection of a suspicious transaction using the disclosed blockchain.

### DETAILED DESCRIPTION

Referring to FIG. 1, there is shown a system 1 in which two parties wish to make a transaction.

To enable the transaction to occur, a purchaser 2 and a vendor 4 are arranged to communicate, either directly or indirectly. The purchaser 2 is able to transfer an amount of a currency to the vendor 4 and in return the vendor 4 is able to transfer a good to, or performs a service for, the purchaser 2.

A third party 6, such as a notary or an investor 6 is able to oversee the transaction. The third party 6 is arranged to communicate with at least one of the companies in order to receive, and optionally verify, information relating to the transaction.

The system 1 also comprises a trust 8. The trust 8 is capable of issuing a digital currency, e.g. a cryptocurrency and/or a virtual currency, in the form of a coin to the purchaser 2. The purchaser 2 can then use this coin to complete the transaction. In order to enable the trust 8 to issue the coin to the purchaser 2, the trust 8 is arranged to communicate either directly or indirectly with the purchaser 2.

The trust 8 is also arranged, either directly or indirectly, to communicate with the vendor 4. After receiving the coin from the purchaser 2, the vendor 4 is able to exchange this coin for fiat currency at the trust 8.

Referring to FIG. 2, there is shown a computer device 1000 on which aspects of the methods and systems described herein are implemented.

The computer device 1000 comprises a processor 1002, a communication interface 1004, memory 1006, storage 1008, removable storage 1010 and a user interface 1012. These components are arranged to communicate via a bus 1014. The user interface 1012 comprises a display 1016 and an input/output device, such as a keyboard 1018 and a mouse 1020.

The processor 1002 executes instructions, for example instructions stored in the memory 1006, the storage 1008, and/or the removable storage 1010.

The communication interface 1004 facilitates communication between each of the purchaser 2, vendor 4, third party 6, and trust 8. The communication interface may for example comprise an Ethernet connection, an infrared connection, or a Bluetooth® connection.

The memory 1006 stores information for use by the processor 1002. Typically, the memory comprises both read-only memory (ROM) and random-access memory (RAM).

The storage 1008 enables long term-storage of information; the storage 1008 typically comprises a hard disk device (HDD) and/or a solid-state drive (SSD).

The removable storage 1010 provides further storage for the computer device 1000. The removable storage may, for example, comprise an interface for a universal serial bus (USB) device. The removable storage 1010 may also comprise online storage, such as a cloud storage account.

Each of the purchaser 2, vendor 4, third party 6, and trust 8 use computer devices 1000 to implement aspects of the methods and systems as described herein. The computer devices 1000 used may be the same, but in most implementations the computer devices 1000 will differ from one another somewhat to suit the different specific purposes and functions of the purchaser 2, vendor 4, third party 6, and trust 8 respectively.

Typically, the third party 6 is interested in recording aspects of transactions. Therefore, the third party 6 may use a device with a large storage capacity, e.g. the storage 1008 is a storage device with large capacity. The computer devices 1000 on which the purchaser 2 and vendor 4 are implemented are typically personal devices, such as personal computers, laptop computers, and tablet computers.

A computer program product is provided that includes instructions for carrying out aspects of the method(s) described below. The computer program product is stored, at different stages, in any one of the memory 1006, the storage 1008, and the removable storage 1010. The storage of the computer program product is non-transitory, except when instructions included in the computer program product are being executed by the CPU 1002, in which case the instructions are sometimes stored temporarily in the CPU 1002 or memory 1006. It should also be noted that the removable storage 1008 is removable from the computer device 1000, such that the computer program product is held separately from the computer device 1000 from time to time. Different computer program products, or different aspects of a single overall computer program product, are present on the computer devices 1000 used by the purchaser 2, vendor 4, third party 6, and trust 8, as evident from the description below.

Different aspects of each party may be operated on a plurality of different computer devices 1000. Further, a plurality of computer devices 1000 may be utilised in the confirmation of a transaction and/or the storage of a transaction ledger. More generally, a combination of computer devices 1000 may be used to store relevant information and carry out aspects of the methods described herein, where these computer devices 1000 may each store copies of the same information, or may store differing information that can be combined.

In some embodiments, aspects of the methods described herein are implemented using blockchain technology and/or a distributed ledger, which are stored upon a plurality of computer devices. This distributed ledger may, for example, store information about the implemented digital currency, which may relate to previous transfers of digital currency and/or current owners of coins to which digital currency is assigned. The purchaser 2, vendor 4, third party 6, and trust 8 may use, at various times, different computer devices 1000 to carry out aspects of the methods, where different computer devices 1000 may have different permissions, so that only on certain systems, or with certain passwords, can a party access certain information and/or system capabilities.

Each of these parties is typically a node of the blockchain and/or the distributed ledger. The nodes of the blockchain may comprise each party that is: connected to, uses, views, validates, proposes blocks for, mines blocks of, adds to, or interrogates the blockchain.

In order to add information to the blockchain, a transaction containing the information is validated by a first node of the blockchain. once the transaction has been validated, the transaction can be included in a block that is proposed for addition to the blockchain. Typically, a plurality of transactions are included in each block. A node that validates transactions may also propose blocks for addition to the blockchain. Equally, different nodes may perform these different functions.

Once the transaction has been included in a proposed block, this block is propagated through the network. If this block receives approval from the other nodes of the blockchain, the block becomes a part of the blockchain. Receiving approval may involve the verification of a consensus mechanism, such as a proof of work consensus mechanism or a proof of stake consensus mechanism. For example, a node may need to solve a proof of work problem before proposing a block, where the addition of the block to the blockchain is dependent on a valid solution to this proof of work problem being provided.

In some embodiments, each node has access to separate records on the blockchain. However, typically, the distributed ledger is accessible by every party (although this ledger may contain information that not every party can view). There may also be certain data that is held solely on the computer device 1000 of a subset of the nodes.

The blockchain is arranged to store information relating to the transactions that occur in the system 1, such as a transaction amounts and transaction participants. This typically involves receiving information via the communication interface 1004 of the computer device 1000 used by each party, where a party that wishes to make a transaction (e.g. the purchaser 2) submits this transaction to a node of the blockchain.

Typically, a transaction relates to a transfer of an object between two parties (e.g. the purchaser 2 transferring a coin to the vendor 4). More generally, a transaction may relate to any change in the state of an object on the blockchain, which change in state can be validated and then included in a proposed block. In an example, the purchaser 2 may transmit a transaction that indicates the purchaser has moved from a first location to a second location. This change in the location of the purchaser can then be recorded in a block and stored on the blockchain.

The transmission of a transaction may require manual input from a person. Equally, a transaction may be transmitted to a node of the blockchain by a computer device. So the phone of the purchaser may identify a change in location via a GPS interface and may then transmit a transaction that indicates this change in location so that a user of the blockchain can identify the change in the location of the user and the time of the change in location (based on a timestamp of a block of the blockchain that contains the relevant transaction).

The transaction is typically associated with one or more objects, which objects may include:
A coin. Coins are associated with an amount of currency and may include a value and/or a denomination. A coin may hold value itself, e.g. the coin may be exchangeable for an amount of a fiat currency. Equally, the coin may be a record of a separate store of value, e.g. a coin may have no inherent worth, but may be used to record the ownership of, and transfer of, an amount of fiat currency.
A good. Goods may be recorded on the blockchain and associated with goods in the world. For example, a good may be recorded on the blockchain alongside one or more of: a type of good, a characteristic of the good and a location of the good. Any changes to the real world good (e.g. a movement of the real world good) can be recorded on the blockchain in association with the good on the blockchain so that a user of the blockchain can assess the characteristics of the real world good by querying the blockchain.
A document. Exemplary documents include contracts, bills of laden, and memorandums. Typically, documents provide context and/or justification for a transfer of a coin or a good. For example, the transfer of a good (on the blockchain) between a first party and a second party may be dependent on the furnishing of a contract that confirms the second party has taken receipt of the good in the real world.

Each object is associated with a related containing set; for example:
Coins are associated with wallets, where each wallet may contain a number of coins. Typically, each coin is associated with only a single wallet, since each coin can only be owned by a single party.
Goods are associated with inventories. As with coins, each good is typically associated with only a single inventory.
Documents are associated with document pools. Documents may be associated with a single document pool. Equally, some documents may be associated with a plurality of document pools, since a document might be of relevance to a plurality of parties. Typically, a single instance of a document is associated with only a single document pool (instances of objects are described in more detail further below).

The association between an object and a containing set makes clear the custodianship of the object, e.g. if an object is in a containing set associated with a first party, then it is clear that this first party is the custodian of the object. Furthermore, this association enables straightforward enforcement of transaction requirements, e.g. an object is typically only transferable by the party that is the custodian of that object.

Transactions transmitted to nodes of the blockchain are typically associated with one or more party, one or more objects, and one or more containing sets. In a simple example, a transaction may relate to the transfer of a coin between a wallet of a first party and a wallet of a second party.

According to the present disclosure, a transaction may be associated with a plurality of types of objects, so that a transaction may be associated with both a coin and a document, which document may justify the transfer of the coin. In some embodiments, the validation of a transaction by a node of the blockchain is based on the transaction being associated with a plurality of types of objects, where this requirement can be used to enforce the provision of evidence for any transfer of objects. Validation may be dependent on each of the above types of objects being provided, or on a subset of these types of objects being provided. For example, a transaction may be associated with a coin and a good, where this transaction can be inferred to be related to a transfer of the good in return for the coin. Equally, validation may further require an association of the transaction with a document, which document may evidence the transfer.

The process of validation typically comprises a node of the blockchain confirming that a transaction meets transaction requirements associated with the blockchain. For example, where a transaction relates to the transfer of an object from a first containing set to a second containing set, validation may comprise the node checking that a private key relating to the first containing set has been evidenced. More generally, the node may ensure that permission to transfer the object has been granted by a party associated with the first containing set.

It will be appreciated that other transaction requirements may be implemented, and that the transaction requirements may depend on a type of transaction being performed and/or a type of object referenced by the transaction. For example, transactions that reference a coin may also be required to reference a document, whereas transactions that reference a document may not be required to reference a coin. Transaction requirements may be enforced by conditions defined on the blockchain. Equally, transaction requirements may be enforced by smart contracts. Through the use of smart contracts, different transaction requirements can be provided for different objects and/or containing sets. In particular, each containing set may be associated with a smart contract, where validation of a transaction relating to an object in said containing set is dependent on requirements defined in this smart contract.

Once a transaction has been validated, it can be included in a block that is proposed for addition to the blockchain. If a transaction is not validated (e.g. if it does not meet the transaction requirements), then this transaction is not eligible for inclusion in a proposed block. The nodes that validate transactions and the nodes that propose blocks are typically the same nodes; equally, these may be different nodes.

It will be appreciated that the above examples of objects and containing sets are exemplary and further objects and containing sets may be implemented. For example, there may be provided an object type that is a person, where the person-type object may describe physical characteristics, an employment status, a skillset etc. A person-type object may be stored in a team-type containing set. Typically, the blockchain is arranged to record at least coins, goods, and documents. The blockchain may also be arranged to record persons. The blockchain may also be arranged to record other types of objects.

The information is typically stored in the form of a distributed ledger held by one or more of the parties. Each party may be restricted to viewing only relevant parts of the ledger. Typically, the ledger relates to a number of (possibly unrelated) transactions that occur between numerous parties. Each party may only able to view detailed information about transactions in which that party was involved.

In some embodiments, the information is instead stored in the form of a centralized ledger, which is held by a subset of the parties involved. A combination of centralized and distributed ledgers may also be used, where centralized ledgers may be used to store potentially sensitive information.

The system 1 is typically a permissioned system, where only authorised parties are allowed to participate in the system 1 and in any transaction. By limiting possible transactions to parties in the system 1, only trusted parties are able to hold and/or use the objects on the blockchain.

### Provenance Information

For each interaction that takes place within the system 1 (e.g. for each transaction), provenance information is recorded on the blockchain. More specifically, the methods and systems described below provide a way to record provenance information on the blockchain, so that this provenance information can be queried by users of the blockchain.

Provenance information relates to a record that describes the people, institutions, entities, and activities involved in producing, influencing, or delivering a piece of data or a thing. In particular, the provenance of information enables an informed decision to be made as to whether information is to be trusted, how this information should be integrated with other diverse information sources, and how to give credit to the originators of this information when it is reused.

By analysing the stored provenance data, it is possible to identify the entities involved in a series of transactions, changes in ownership of an object, and the context of the transactions.

Typically, some or all provenance data requires verification and/or validation, e.g. by the third party 6, before being added to the blockchain. This enables parties viewing the blockchain to be confident that the provenance information is correct. Whether provenance data requires verification/validation may depend on the type of information.

The provenance data may include one or more of:
An indication of the parties to a transaction;
An indication of what is being transacted (e.g. transferred); e.g. a coin
Time data, in particular the time at which a transaction was first transmitted to a node of the blockchain and/or the time at which a transaction was recorded on the blockchain.
Location data; e.g. where a transaction has taken place in the world. This may be based on GPS data of a computer device transmitting the transaction.
An indication of why the transaction occurred; this may be determined based on a feature of the transaction, such as a document referenced by the transaction.
An association with other transactions. For example, there may be recorded on the blockchain a reference to other similar transactions recorded on the blockchain. Such similar transactions may be determined by a node receiving the transaction (e.g. a validating node).

Referring to FIG. 4, there is shown a system 2000 comprising a plurality of modules on which aspects of the disclosures herein may be implemented. In particular, one or more of the following modules may be implemented by a node of the blockchain—and these modules may be provided in any combination, where different nodes may implement different modules depending on a purpose of that node (e.g. whether the node is a validating node or a viewing node):
An identifier manager 2010. The identifier manager provides management of identifiers to assist in the creation of a precise record of historical information. In particular, each object and each containing set is typically associated with an identifier.
   Each object and each containing set is typically associated with a persistent identifier and/or an ephemeral identifier. A persistent identifier, which may be a serial number, persists through the lifetime of the object (e.g. from the creation of the object through to the destruction of the object) and can be used to identify the object throughout the blockchain. An ephemeral identifier is updated as the object is referenced in transactions. More specifically, the ephemeral identifier is typically updated after each transaction that references the object, so that a user of the blockchain can immediately identify that an object has been referenced by transactions. In some embodiments, the ephemeral identifier is instead updated after each change of state of the object (so that where an object is referenced, but no state of the object changes, the ephemeral identifier may stay the same).
   Furthermore, the ephemeral identifier enables a user of the blockchain to identify an instance of an object, so that a user can distinguish between an object that has just been created, an object that has been used a few time, and an object that has been used many times. Therefore, each time that an object is referenced in a transaction, an instance of that object is updated.
   Typically, the updating of the ephemeral identifier comprises incrementing the ephemeral identifier. More generally, the ephemeral identifier may comprise any unique identifier (so that each instance of each document and containing set is unique).
   Typically, the updating of the ephemeral identifier is performed by a node processing and/or validating a transaction. Specifically, a node may receive a transaction from a party involved in the transfer of an object, determine an existing value of the ephemeral identifier, update the ephemeral identifier, and then include the updated identifier in a proposed block. Determining the existing value of the ephemeral identifier may comprise identifying a most recent value of the ephemeral identifier that is recorded on the blockchain. This may comprise identifying the latest block of the blockchain that references the object. Equally, this may comprise identifying each previous reference to the object and identifying the most recent use.
   Typically, each transaction is recorded on the blockchain along with the permanent identifiers of any objects associated with the transaction and the existing and/or updated ephemeral identifiers. However, in various embodiments only one of these identifiers is recorded, where the other identifiers can be obtained by evaluating the remainder of the blockchain. For example, where only the persistent identifier is recorded on the blockchain, the existing and updated ephemeral identifiers may be determined by identifying every reference to the object on the blockchain and then iteratively calculating the ephemeral identifiers.
   A blockchain may construct ephemeral identifiers by concatenating a value to a persistent identifier, for instance, using the example of a car (which may be recorded as a good on the blockchain):
      Car persistent identifier: <car/1234>
      Car ephemeral identifier #1<car/1234/2500>
      Car ephemeral identifier #2<car/1234/2501>
      Car ephemeral identifier #3<car/1234/2502>
   Identifiers are typically managed according to properties of objects. Exemplary properties include:
      Custody: An object may have a single owner at any one time (since, e.g. when a parcel is with a recipient, it is no longer with the courier, and vice-versa). In some embodiments, an object may have multiple owners, since an individual may have two different employments.
      Replicability: An object may or may not be replicable (an electronic document may be copied, a physical document could be photocopied, whereas a given car is unique and identified by a unique number). Replicability typically determines whether an object can be present in a plurality of containing sets. Where an object is replicable, typically each version of the object is associated with different, but related, identifiers, e.g. a first version of a document may have the persistent identifier doc/1234/1 and the second version of this document may have the persistent identifier doc/1234/2
   Further characteristics of objects may also be captured alongside identifiers. In particular, attribute data relating to the objects may be collected (e.g. location, time, cost, weight, make, etc).
A containing sets manager 2020. This module maintains all existing containing sets, and the identifiers of all the objects they respectively contain.
   Typically, containing sets also have identifiers, e.g.:
      Document pool associated with room 234: <books/room234>
      Document pool associated with room 234 after a number of transfers of documents: <books/room234/35>
   A containing set may enumerate all the object identifiers it contains, which identifiers may be ephemeral identifiers. A containing set thus provides a snapshot of the custodianship of an object of the blockchain and also provides a snapshot of the holdings of a node of the blockchain.
   The containing set manager 2020 typically does not keep a record of previous contents of containing sets. These previous contents can instead be recorded in mined blocks.
   Containing sets are typically not replicable and thus each containing set has a single instance at any point in time.
   In this regard, as with objects, the instance of each containing set is typically updated each time that containing set is referenced by a transaction on the blockchain. Therefore, the instance of the above-mentioned document pool may be updated (e.g. incremented) each time a document is transferred into or out of the document pool. Similarly, the instance may be updated if a state of a document in the document pool changes (e.g. if a transaction is transmitted that identifies a document is damaged).
   Typically, the containing set manager 2020 operates in conjunction with the identifier manager 2010 to enable:
      The creation of objects in a containing set.
      The changing or transformation of objects within a containing set.
      The deletion of objects from a containing set.
      The transfer of objects from a first containing set to a second containing set.
      The querying of a containing set (e.g. to identify which objects are present in a training set).
   Creation: creation is concerned with the original creation of an object and its assignment to a containing set. Before the creation of an object, the object does not exist. After creation, a new containing set contains the ephemeral identifier to this object. Examples: minting a coin in a wallet, or onboarding a new employee in a team.
   Change: As an object (with persistent identifier <object/x>) changes (through a transaction) from a first state to a second state, respectively denoted by identifiers <object/x/1> and <object/x/2> the containing set changes accordingly. A containing-set enumerates the persistent identifiers of the objects it contains, and their corresponding ephemeral identifiers, at that point in time; for example,

∘ pre-transaction, <set/s/1004> maps

▪ <object/x> to <object/x/1>
▪ ....

∘ post-transaction, <set/s/1005> maps

▪ <object/x> to <object/x/2>
▪ ....

Deletion: before deletion, an object was part of a containing set, after deletion, the containing set is updated not to include the object. Example: an employee resigns and leaves a team of workers.
Transfer: A transfer changes the custody of an object, which is expressed by their identifiers being “moved” from a first containing set to a second containing set.
Query: A query results in the containing-set returning the ephemeral identifier of an object it contains, which object is identified by its persistent identifier.
Exemplary containing sets include:
   A wallet is a containing set for coins.
   A document pool is a containing set for documents.
   An inventory is a containing set for goods.
   A team is a containing set for people.
   A shelf is a containing set for books.
   A fleet is a containing set for vehicles.
These containing sets may be organised into a hierarchy of containing sets. For example, a shelf may be a type of document pool and a fleet may be a type of inventory. In general, the use of wallets, document pools, inventories, and teams can be used to track the flows of cash, documents, goods, and people. The use of further containing sets may allow more granulated tracking of flows.
A transaction enactor 2030 that receives requests to enact transactions.
   For each transaction, pre-transaction objects can be distinguished from post-transactions objects.
   As input, the transaction enactor 2030 typically requires all the pre-transaction objects to be specified, e.g. in the form of their persistent object (serial identifier) and/or their containing-set.
   From these inputs, the transactions enactor 2030 is able to query the containing sets manager 2020 and/or the blockchain to derive the ephemeral identifiers of pre-transaction objects.
   For each type of transaction, the transaction enactor 2030 encodes the business logic, e.g. to transfer a coin from containing-set (wallet1) to containing-set (wallet2), to ensure that the coin is present in wallet1, and to ensure that the party transmitting the transaction is authorised to make this transfer.
   The authorization component 2100 of the transaction enactor 2030 ensures that transactions are according to policy.
   The validation component 2150 of the transaction enactor validates transactions based on the transactions allowable (e.g. according to policy).
   As the transaction enactor 2030 enacts a transaction, making use of the identifier manager 2010 and the containing sets manager 2020, it creates a record of the transaction, which transaction can be included in a block 2040 of the blockchain.
      The block uniquely identifies the transaction taking place.
      The block contains a record of the initial request to perform a transaction 2031.
      The block typically contains ‘PROV-Lets’ 2050, which are records detailing primitive aspects of the transaction, in terms of the functionality of the containing-set manager. In particular, the PROV-Lets identify the following type of transactions, including all the pre and post identifiers, persistent and ephemeral, for all objects they refer to.
         Any creation of an object in a containing set.
         Any change of an object within a containing set.
         Any deletion of an object from a containing set.
         Any transfer of business object from a containing set to another.
   According to each the type of transaction being undertaken, there will be one or more of these primitive aspects.
   Each primitive aspect is described by one or more PROV-Let records, which PROV-lets typically contain:
      A transaction identifier.
      The type of primitive operation.
      Identifiers of an object associated with the transaction (e.g. serial and/or ephemeral identifiers, and/or pre-transaction and post-transaction identifier values).
      Identifiers of the containing set (e.g. serial and/or ephemeral identifiers, and/or pre-transaction and post-transaction identifier values).
      Relevant attribute data pertaining to the object or containing sets.
   In order to simplify the retrieval of information from the blockchain, in some embodiments for a given transaction all relevant PROV-Lets in the block are required to share the same transaction identifier. This field can be indexed so as to allow for ease of retrieval. This requirement may be enforced via smart contracts and/or validation requirements (e.g. so that a block that does not meet this requirement cannot be added to the blockchain).
   While the containing-set manager 2020 typically contains a full description of all the containing sets, the PROV-Lets that are recorded in a block of the blockchain may contain only the differences to apply to the containing sets that existed before a transaction. The full description can then be recovered from these differences.
   The transaction enactor 2300 is typically implemented on a validating node, where the validating node receives a transaction, ensures the transaction is valid using the authorization component 1100, identifies or creates the requisite records (e.g. updates the ephemeral identifiers of each object and containing set referenced in the transaction), validates the transaction using the validation component 2150, and then transmits the transaction to a further node. This transmission to a further node may comprise confirming the validity of the transaction, transmitting a proposed block comprising the transaction, and/or validating a block comprising the transaction.
A mined blocks module to evaluate information recorded on mined blocks 2060 of the blockchain.
   Blocks are added to the blockchain by nodes of the blockchain (including validating nodes and/or mining nodes), who validate the transactions before addition to a block based on the transaction meeting the requirements of the blockchain (e.g. based on the above information being recorded in PROV-Lets associated with the transaction, and based on an object being stored in a containing set related to a party that is making the transaction).
   The discrete nature of the transactions discussed above is visible here, as a distributed ledger typically does not expose an intermediary state before a block is fully mined. Either a block has been mined or it has not. This being said, depending on the consensus mechanism of the blockchain, recently mined blocks may not be fully trusted until they have reached a certain depth in the blockchain.
   Mined blocks contain all the PROV-Lets that have been recorded by the transaction enactor 2300 and are effectively immutable.
   The PROV-Lets of the mined blocks allow for a part of or the whole of this immutable historical record to be retrieved (and converted into a knowledge graph as described below).
   Due to the distributed ledger architecture of the disclosed blockchain, there is a guarantee that all semantics constraints required for the business transactions have been adequately enforced, and therefore the records formed by PROV-Lets represent a faithful description of enactment, which further has been checked by nodes who have validated each included transaction and reached a consensus on a history of the blockchain.
A PROV-Let Query module 2080 that is arranged to retrieve PROV-Lets from mined blocks of the blockchain.
   To do this, the PROV-Let Query module 2080 exploits the transaction type declaration 2070, and in particular, the expected PROV-Lets for the transaction types of interest. This may comprise receiving query parameters, including, but not exclusively:
      A range of block identifiers, or a time range.
      Transaction types (or all types by default).
      Further parameters, such as serial identifiers of objects, characteristic data, etc.
      The PROV-Let Query component returns a list of minted blocks and/or a list of PROV-Lets in the blocks.
   In terms of accountability, there is a desire for query results to be reproducible. Therefore, according to the present disclosure, periodical reports (daily, monthly, . . . ) can be built on queries, which are executed as part of regular transactions (and thus reproduced, verified and mined by miners). As a result, all blocks identifiers retrieved by a query can be stored as a distinct record.
A knowledge graph construction module 2090 that provides a mechanism to create knowledge graphs, from the blockchain.
   The type of knowledge graphs constructed may consist of nodes representing object states, at various points of their lifetime, and labelled edges, which are interdependencies dictated by transactions. The combination of such nodes and edges form a knowledge representation of transactions, which can be queried, reasoned over, and analysed.
   The knowledge graph construction module 2090 makes use of the PROV-Lets returned by PROV-Let Query module 2080 and transaction type declarations 2070 to build a knowledge graph.
   The knowledge graph may be built on chain or off-chain according to the implementation of the blockchain.
   The knowledge graph is reproducible and verifiable by third parties, and builds on query results 2080, business transaction types, expected PROV-Lets and knowledge graph creator functions all stored in mined blocks 2070.
   Each knowledge graph creator function takes as input a grouping of PROV-Lets for the expected PROV-Lets declared in the mined blocks 2070, and constructs a Knowledge graph representation accordingly.
   For example, the PROV-Lets may be used to construct a knowledge graph according to a W3C provenance standard and templating mechanisms (such as those described in “A Templating System to Generate Provenance; Moreau et al.; IEEE Transactions on Software Engineering; Volume 44 (2) (February 2018); https://ieeexplore.ieee.org/abstract/document/7909036”)
   The Knowledge Graph can be encoded in graph databases such as Neo4j or RDF stores, and queried by the appropriate query language, Cypher and Sparql, respectively.
   Such knowledge graphs allow the tracking of flows of objects (e.g. coins, goods, people, documents).
   Beneficially, the disclosed blockchain enables the straightforward construction of a Knowledge Graph.
An authorization module 2100 that ensures that transactions are executed with the right level of authorization.
   Request for transactions submitted to the blockchain are signed by the party making the request.
   This party needs to have the right to access the pre-transaction objects operated on by the transaction: for instance, to transfer a coin, the party needs to have the coin in its wallet before the transaction; to be able to read a document, the document should be in the party's document pool.
   Containing sets also have a reference to the public cryptographic key of the party with which they are associated.
   Before executing a transaction, the transaction enactor 2300, through its authorization module 2100 will ensure that the key that signed the transaction is the one associated with the relevant containing set.
   A mechanism of delegation may be provided whereby a first party allows a second party to process elements of a containing set associated with the first party. This delegation may be based on the sharing of a private key between the first party and the second party or based on a condition of a smart contract associated with the containing set. In particular, the first party may define the parties able to process elements of a containing set by reference to public keys of nodes of the blockchain (where the provision of a private key corresponding with one of these public keys authorises the processing of elements).
A validation module 2150 that ensures that transactions are valid and then validates these transactions. As has been explained above, before a transaction is included in a block of the blockchain it may require validation by a validating node of the blockchain. The validation module performs this validation, which typically comprises ensuring that the transaction meets a set of requirements. These requirements may be determined from the blockchain and/or from a smart contract and typically comprise the authorization requirements described above with respect to the authorization module 2100.
A transaction external executor 2200
   Components 2000-2100 of the transaction external executor 2200 ensure the construction of a verifiable, reproducible, auditable knowledge graph for the purpose of providing an accurate, query-able and analysable knowledge graph describing real-world business transactions.
   The blockchain can be used either to perform transactions or to describe transactions (or both); for example, the blockchain may be associated with the transfer electronic coins, or the exchange electronic documents.
   For certain types of transactions, the blockchain needs a mechanism to enact the transaction in the physical world. This includes:
      Receiving input from users.
      Recording the transportation or movement of physical objects.
   Actuators can be controlled by the transaction external executor 2200 and sensors can feed data back to it. In particular, the transaction external executor 2200 may be arranged to receive information from sensor devices and/or transactions containing information from sensor devices. Such transactions are typically automated, where the recording of information by a sensor device (e.g. the scanning of a barcode by a barcode scanner) can be used to automatically form or transmit a transaction.
A problem handling module 2300
   At multiple steps, the nodes of the blockchain can identify problems including:
      An unknown persistent identifier 2010.
      An attempt to replicate a non-replicable object 2010.
      An incorrect claim that an identifier belongs to a certain containing-set 2020.
      A business pre-condition not holding (e.g. not enough funds being available before a payment is made 2030.
      No consensus reached on a transaction 2040-2060.
      A transaction issuer not being authorized to perform a transaction 2100.
   Such problems typically result in a transaction or a block being rejected (e.g. not validated). Equally, some problems may not prevent the validation of a transaction or a block, but may instead raise a flag (that may be transmitted to various nodes of the blockchain). Such a flag can be used to identify transactions that merit further investigation.
   Problems are typically handled by the problem handling component 2300, which sends notifications to subscribers and/or raises exceptions, as the transaction is performed.
   Transaction requests associated with problems can also be stored for further analysis.
An export to GS1 module 1091.
An import from GS1 module 1093, 1031.
   These modules convert information from a GS1 format to an expected format (and vice versa). This requires enriching the GS1 format with containing set identifiers. This task can be facilitated by defining default containing-sets associated with agents. In the absence of a specified containing-set, then the default containing set of that type will be used for the relevant agent.
   More generally, there may be provided modules that convert data from, and/or export data to, a desired format.
   The use of ephemeral identifiers provides assurance as to the instance of each object. Furthermore, the use of blockchain enables the determination of a time to be associated with each instance of an object (e.g. this time may be the timestamp of a block of the blockchain in which the instance is recorded).
   Therefore, the exportation of data may comprise the determination of an object, or an instance of an object, associated with the data being exported and the injection of this determined data into the exported data. In particular, a time associated with a transaction may be determined based on an instance of an object associated with that transaction.
   This is of particular relevance to GS1, where information in a GS1 format may contain only a local time. Therefore, where an object is associated with different GS1 datapoints (e.g. a barcode that has been scanned at two different locations), it can be unclear which of these datapoints came first. For example, a good may be scanned at 2 pm in Boston and then at 5 pm in London, where it may be unclear to a viewer of a related GS1 record which of these scans occurred first (since it is unclear whether 2 pm relates to 2 pm GMT or 2 pm Eastern Time). Using the blockchain, each of these scans results in a change of the state of the good that is recorded on the blockchain, and each transaction results in the ephemeral identifier relating to the good being updated. Therefore, the blockchain enables the event occurring first to be determined and enables the event data to be put into an appropriate order before being exported.
   In some embodiments, a time associated with an object may be interpreted based on an instance of the object (e.g. if the Boston scan is associated with a first instance and the London scan is associated with a second instance it can be inferred that the Boston time is 2 pm GMT).
   Therefore, the export module 1091 and the import module 1093, 1031 may be arranged to process a plurality of instances of an object so as to determine an order of the instances and to export data relating to the plurality of instances in dependence on the order. This enables a user of the blockchain to export information in a standard format (e.g. GS1) while injecting information into this format to enable the evaluation of an object's history.
   The import module 1093, 1031 also enables a user to upload historic information to the blockchain in order to provide provenance information so that a user can join the blockchain and quickly build up trust/provenance information/scores for this user and for any associated objects/containing sets.
   The ability to transform and record GS1 information also simplifies the process of tracking goods. For example, a barcode may be scanned to identify the receipt of a good, where this scanning results in the storage of GS1 information on the blockchain. This enables the information relating to a good (and an inventory) on the blockchain to be updated following the input of GS1 information relating to a physical good in the world. Therefore, goods on the blockchain can be efficiently tracked and updated based on the input of GS1 information relating to physical goods in the world (e.g. the scanning of a barcode).

As has been described above, the mined blocks 2070 contain PROV-Lets that enable the reconstruction of the information stored on the blockchain. These blocks may indicate, for example, indicate:
Transaction types (e.g. minting a coin, transporting some goods, . . . ).
The types of PROV-Lets that are expected to be found in minted blocks for this transaction type.
A reference to the code (or the code itself) to construct a knowledge graph (KG) from the recorded PROV-lets.

The reconstruction of this information into an interpretable format may be based on a module, or an application, of a computer device. In particular, a computer device may be arranged to read information from the blockchain and to present this information in a certain format. The desired format is likely to change over time as the information is used for different purposes and in different situations. For instance, a new regulation may require extra data about vehicles to be recorded to ensure compliance with the regulation, where this new regulation may lead to a program being updated in order to extract this information from the blockchain.

Due to changes in real world needs and capabilities, the information stored in the blocks 2070 may evolve over time. With the above example of a new regulation, blocks mined before the regulation is created may not contain the requisite extra data, while blocks mined after the regulation is created may contain this extra data.

Therefore, the blockchain may be arranged to store an indication of an interpreter version in one or more blocks of the blockchain (where the storing of this interpreter version may be a requirement for the validation of a block). This indication can be referenced by a computer device that is querying the blockchain so that the computer device is aware of the information recorded in a block of the blockchain and can determine a suitable method for interpreting this information. With the above example, a computer device querying the blockchain is able to identify a first set of blocks that does not contain the extra data and a second set of blocks that does contain the extra data based on interpreter version indicators stored in the relevant blocks. The computer device can then interpret the first set of blocks and the second set of blocks differently. If a piece of the required extra data is missing from one of the second set of blocks, the computer device may raise an alarm, whereas such missing data is expected in the first set of blocks and so no alarm would be raised. Similarly, a value that is concerning when stored in the second set of blocks (e.g. a high emission level) may not be concerning when stored in the first set of blocks. The storing of the interpreter version indicator ensures that present day thresholds and regulations are not inadvertently retroactively applied to old data.

The recording of provenance information on the blockchain enables flows in the environment to be tracked. Typically, the blockchain is configured so that the provenance information is stored on the blockchain, which provenance information enables the tracking of flows of objects (e.g. coins, goods, people, documents) between containing sets. Exemplary flows include:
1. The flow of currency, such as the flow of coins. Currencies are typically associated with (electronic) wallets, e.g. a user may have a wallet that holds a coin.
2. The flow of traded goods. Goods are typically associated with an inventory.
3. The flow of people. People are typically associated with teams.
4. The flow of documents, such as orders, acknowledgements, and/or certificates. Documents are typically associated with a document pool.

The provenance information may be used to track numerous activities; for example:
Registering something in a containing set, e.g.:
   Minting a coin in a wallet.
   Creating goods in an inventory.
   Creating a document in a document pool.
Exchanging something between two containing sets, e.g.:
   Transferring a coin between wallets.
   Exchanging goods between inventories.
   Moving a document between document pools.
Transporting something between two locations, e.g.:
   Transporting physical goods to another location (these goods may move to a different version of the same inventory).
   Delivering a physical document to another location (this document may move to a different version of the same document pool).
Transforming something, e.g.:
   Splitting and/or combining a coin.
   Transforming and/or assembling goods.
   Deriving a second document from a first document.

Typically, each of these activities requires the movement of an object between containing sets and/or the change of a state of an object.

Typically, the blockchain is arranged so that each object must be associated with a containing set. Depending on the implementation and the object, objects may only be associated with a single containing sets or objects may be associated with a plurality of containing sets.

Typically, objects may be specified to be either replicable or unique. For example, there may only be one occurrence allowed of any good, while a plurality of occurrences of a document may be allowed. Where a plurality of occurrences of an object are allowed, these occurrences are typically given different, but related, identifiers so that a user of the blockchain can identify and distinguish between each occurrence (and so that each object on the blockchain still has a unique identifier).

In order to enforce the desired association of objects and containing sets, the validation of transactions may be dependent on one or more smart contracts, which smart contracts limit the recording of information on the blockchain. For example, each smart contract may require each object to be associated with a containing set. Equally, the validation requirements of the blockchain may directly impose these requirements.

Typically, transactions are associated with a plurality of different types of objects. For example, transactions associated with the flow of coins are also associated with the flow of goods and/or documents. Therefore, a transaction may require a transacting party to reference at least two different types of objects. Following each transaction, the instances of each of the objects and containing sets referenced in the transaction are updated. The interdependency between the objects may then be stored on the blockchain, so that a user is later able to identify that a coin was transferred based on, say, a document. This provides context for the state transitions shown by the knowledge graph.

In this regard, each object may have an associated status, which status can be updated with, and/or identified based on, the instance. In particular, each object may be identifiable as ‘valid/alive’ or ‘invalid/expired’. This enables a user to easily identify, for example, which objects have been used.

Updating the identifier relates to determining a new identifier to be recorded on the blockchain. In practice, a node that is updating the identifier typically determines a new identifier to be recorded on the blockchain, where this new identifier may be based on an existing identifier (e.g. the new identifier may relate to the existing identifier being incremented). The creation of such a new identifier constitutes the updating of the existing identifier.

As an example of this updating, a zeroth instance of a coin may relate to the coin being newly minted and may be associated with the ephemeral identifier coin_0, a first instance of said coin may relate to the coin having been transferred once may be associated with the ephemeral identifier coin_1, and so on. A user attempting to track the passage of an object can search through the blockchain for all of the instances of the object and determine a history of the object based on the various instances recorded on the blockchain.

Where the instance is incremented, a persistent identifier relating to the object is typically left unchanged. Therefore, the object can also be tracked using the persistent identifier. This use of instances and/or a persistent identifier is in contrast to, for example, an unspent transaction output (UTXO) blockchain, where each transaction results in the formation of entirely new UTXOs with no overt link to a previous UTXO. With the present disclosure, an immediate link can be drawn between objects so that the blockchain can be queried to track the history of objects.

In some embodiments, only the flows of objects are tracked, so that the contents of each containing set are not specifically tracked. In order to determine the contents of a containing set, the flows of objects (which are recorded on the blockchain) can be analysed to determine which objects have entered the containing set and which objects have left the containing set. This reduces the storage required to record objects and containing sets on the blockchain by avoiding the storage of redundant information.

In order to transfer objects between containing sets, a cryptographic key is typically required (e.g. a private key relating to an account and or an unspent transaction output of the blockchain). In order to reduce the number of cryptographic keys required to implement the disclosed system, with the present disclosure each containing set is associated with a party and the blockchain is typically arranged so that a cryptographic key relating to this party is usable to control the flow of objects out of a plurality of the party's containing sets. Similarly, a plurality of containing sets relating to the party may be associated with a single address of the blockchain.

Referring to FIG. 5, an exemplary method 100 of minting a coin and transferring that coin to a desired wallet is described. This exemplary method is useable to illustrate the tracking of flows and objects during a transaction. Such a method may be implemented using the transaction enactor 2030.

In a first step 101, a new instance of a coin is created in an agent wallet (wallet 0). This may involve a request being made to the trust 8 that a coin is created, where the trust then creates a coin in the agent wallet. An instance of the agent wallet is then updated (e.g. incremented). This updating is useable to identify that the agent wallet has been involved in a transaction.

In a second step 102, the containing set of the new coin is changed from wallet 0 to wallet 1. This step relates to the coin being moved from an agent wallet into the wallet of a user. An instance of the user wallet (wallet 1) is then updated to identify that the user wallet has been involved in a transaction.

In a third step 103, the presence of a document in an agent document pool is determined. For example, the agent may confirm receipt of a purchase order. The instance of the agent document pool is then updated.

Typically, this involves the agent document pool being updated to indicate that the purchase order has been received and reviewed. Similarly, the instance of the document is updated.

These steps may occur atomically in any order. In practice, the transfer of the coin from wallet 0 to wallet 1 typically occurs in dependence on the presence of the document in the agent pool being determined. Therefore, the user only receives the coin once this document has been provided. The instance of the agent pool is then updated to verify that this document has been provided and that the transfer of the coin has been completed.

Each event (e.g. the minting and the transferring of the coin) is then recorded on the blockchain as a transaction that references: the coin being transferred, the agent wallet, the user wallet, the document, and the agent document pool.

Following the transaction, a user is able to identify that the minting of the coin has occurred in dependence on the document. A user is then able to interrogate this document to see the reasons for the minting of the coin. In practice, this may involve the user interrogating a knowledge graph to identify a relevant document and then interrogating the document itself.

Referring to FIG. 6, a method 110 of performing a transaction is shown. A first party and a second party are the parties to the transaction. The method is typically performed by the computer device 1000 of a node of the blockchain. In particular, the node may perform each step of the method and then record the changes to objects/containing sets in a proposed block of the blockchain. These changes are recorded on the blockchain once this proposed block is propagated through the blockchain network and is accepted by the other nodes of the blockchain.

In a first step 111, the existence of a wallet, an inventory, and a document pool is checked for each of the first party and the second party. The wallet of the first party, the inventory of the first party, and/or the document pool of the first party are typically linked, e.g. related to the same blockchain address and/or private key.

In a second step 112, a document in the document pool of the first party is identified. This document is associated with the minting and/or transfer of a coin. For example, the document may confirm that the first party has deposited an amount of a fiat currency into an account of the trust 8 so that a coin of a corresponding value should be minted and placed into the wallet of the first party.

In a third step 113, a coin is minted and is placed into the wallet of the first party. The minting of this coin is associated with the document, and this association (and/or interdependency) is defined in the transaction so that a user of the blockchain can identify the reason for the minting of the coin at a later date. Typically, the document is then transformed or invalidated to indicate that the purpose of the document has been served. In more complex examples, documents may have a plurality of purposes (e.g. specifying that a coin should be minted and then transferred to the second party). The transformation may then comprise incrementing an instance of the document and/or indicating a purpose that has been served. For example, a zeroth instance of the document may be associated with the coin not having been minted; a first instance of the document may be associated with the coin having been minted and placed into the wallet of the first party; and a second instance of the document may be associated with the coin having been transferred to the second party. The status of the coin can thus be determined by reviewing the instance of the document (where each increment of the instance is recorded on the blockchain).

In a fourth step 114, the coin is split into a first subcoin and a second subcoin. The first subcoin is transferred to the wallet of the second party while the second subcoin remains in the wallet of the first party. The instance of the wallet of the first party and the instance of the wallet of the second party are each updated, as are the instances of each subcoin.

In a fifth step 115, a good is transferred from the inventory of the first party to the inventory of the second party. The corresponding good on the blockchain is then transferred to the inventory of the second party. The instances of each of these objects and each of these containing sets are updated.

The example of FIG. 6 has described the splitting of a coin, it will be appreciated that more generally any object may be split and/or may be combined. For example, a good may be split into constituent parts (e.g. a car may be split into an engine and a chassis) and/or a plurality of goods may be combined (e.g. an engine and a chassis may be combined into a car). With any split or combination, the resultant object is linked (e.g. via the identifier) to the previous objects. Therefore, a good can be tracked not only in terms of transfers of the good between users, but also in terms of modifications made to the good. So a user that receives a good can identify a first user that has sent the good and also a plurality of other users that have sent the constituent parts of the good to the first user. In practice, given a car, the blockchain can be used to determine the origin of the platinum in the catalytic converter. By identifying a user associated with this platinum, a potential buyer can identify if this platinum has been obtained under inhumane conditions.

By providing provenance information for an extended period of time, the described blockchain can also be used to identify fraud. For example, if a user attempts to misrepresent a good (e.g. to represent a used car as a new car) this misrepresentation can be identified by evaluating the blockchain. If a user alters a good on the blockchain associated with the car to change a status of the car from used to new, this can be picked up since an nth instance of the car will show the car as used and an (n+1)th instance will show the car as new. A user can thus identify fraud (since there is no legitimate way for a used car to become a new car). If a user instead attempts to upload a new good to the blockchain that is associated with the car, this fraud can be picked up by a lack of supporting provenance information. For example, any car that is not linked to a chassis and an engine might be deemed to be suspicious. In this regard, each of a car, chassis, and engine can be associated with a good on the blockchain, where typically the goods associated with the engine and the chassis will be referenced by the good associated with the car. In practice, and continuing with the example of a car, a manufacturer of the car will typically be involved in transactions relating to the engine and the chassis (so that it can be confirmed that the manufacturer has created or received the engine and the chassis). The manufacturer will also be involved in transactions relating to the finished car being sent to distributors. So if a car cannot be linked to engine/chassis transactions, this car can be identified as being suspicious and worthy of further investigation.

An example of the minting of a coin, and the effect on objects/containing sets is illustrated using the table below:

| | |
|---|---|
| Activity kind | Coin minting |
| Activity identifier | abc_123 |
| Minted coin | Coin_xyz_1 |
| Coin value | 1000 |
| Coin serial number | Coin_xyz |
| Currency | Dollars |
| Agent | ExampleCorp |
| Document | Doc_def_1 |
| Document serial number | Doc_def |
| Wallet before minting | Wal_ghi_0 |
| Wallet after minting | Wal_ghi_1 |
| Wallet serial number | Wal_ghi |
| Pool before minting | Pool_jkl_5 |
| Pool after minting | Pool_jkl_6 |
| Pool serial number | Pool_jkl |
| Minting date | Jan. 1, 2021 00:00:00 |

As shown in this table, the minting of the coin results in an increment in the instance of the document, the wallet, and the document pool. Each of these objects and containing sets keeps the same serial number, but has an increased instance so that it can be identified that a state of the object/containing set has changed.

In practice, each transmission of a transaction to a node of the blockchain includes at least an activity kind and a persistent identifier of any object being referenced but may not include the other information. The remaining information can be determined by a node validating the transaction and/or adding the transaction to the blockchain. In particular, the instance of the object before minting (or before another primitive aspect) can be determined by determining the last instance of the object that is recorded on the blockchain (based on the persistent identifier of the object) and the instance of this object after mining may be one greater than the instance before mining (though it will be appreciated that other methods of updating the identifier may also be used). Therefore, only a small amount of information is needed to submit a transaction, and the remaining information can be filled in based on this small provided amount.

Where the coin is split (e.g. to transfer only a portion of the value of the coin), each subcoin is still linked to the original coin through information stored on the blockchain. Therefore, each transaction and each transfer can be analysed in order to create a graph of provenance. In a large ecosystem with numerous transfers of cash, goods, and documents this enables any irregularities to be identified (e.g. the transfer of coins to an unusual party). These irregularities can then be interrogated with reference to the documents on the blockchain to identify corruption or inefficiency.

By enforcing semantic requirements for each transaction, and in particular similar formatting for the recording of prevenance information, provenance information is collected in such a way that the blockchain can be queried.

For example, the format of each object and each coin may be standardised. This enables a user to query the blockchain in order to recover information relating to the objects, containing sets, and transactions. In particular, a user may search for any object and determine the flow of this object through the system 1 based on the various instances of this object that have been recorded on the blockchain. Since an identifier of each object is maintained with each transaction while the instance of the object is incremented, it is straightforward to track the movements of the object through the ecosystem and to track any transformations of the object (e.g. the object being split, or the object being combined with another object).

There is thus disclosed herein a method of obtaining provenance information from the disclosed blockchain, a block of the blockchain, and/or the transaction of a blockchain. In particular, a user may query and/or obtain one or more of:
A sender or recipient of an object.
A characteristic of a transaction (e.g. a location, method, involved party etc.).
A reason for a transaction.
An object (e.g. coin, document, and/or good) associated with a transaction, a sender, a recipient, and/or an ecosystem).
A containing set (e.g. a wallet, document pool, and/or inventory) associated with a transaction, a sender, a recipient, and/or an ecosystem).
An instance of an object or a containing set.

This ability to query the blockchain enables the collection and determination of provenance information. For example, similar transactions can be identified (e.g. those involving similar amounts or similar parties) and these similarities can be used to determine provenance information for a second object/containing set/transaction given known provenance information for a first object/containing set/transaction. Furthermore, the reasons for a transaction being performed can be inferred from similar previous transactions for which the reasons are already known. Therefore, provenance information for an object, containing set, or transaction can be determined by identifying a similarity to other objects, containing sets, or transactions.

Furthermore, the provenance information recorded with respect to each transaction can be used to provide a graphical representation of the system 1 (e.g. the aforementioned knowledge graph). The flows of cash, people, goods, and documents through the system and between the parties of the system can be determined and mapped by querying the blockchain. This enables analysis of the transactions recorded on the blockchain. The mapping does not need to be recorded on the blockchain, since it can be formed by any party that is able to query the blockchain.

Referring to FIG. 7a, the use of provenance information to identify a potentially concerning transaction is described.

In this example, a user (User A) requests a payment from a bank (Bank A) based on a document (Document A). This may comprise the user submitting proof of collateral to the bank in return for a loan.

Bank A sends a coin (Coin A) to User A based on the information in Document A.

At a later date, User A submits the same document to a second bank (Bank B). The re-use of this document may be of concern to Bank B, since the collateral mentioned in this document is already being used as collateral for the loan of Coin A. Therefore, a warning may be transmitted to Bank B (e.g. by a computer device that is monitoring the transaction being submitted to the blockchain).

The identification of the re-use of Document A may be based on the identification of a repeated identifier. In particular, where a transaction is submitted to a node of the blockchain for validation, the node may query the blockchain to identify previous use of an object referenced by the transaction. In this regard, a status associated with Document A may be updated when Document A is submitted to Bank A, which status may indicate Document A cannot be used again.

User A may attempt to hide the re-use of the collateral by modifying the document in an attempt to differentiate the document submitted to Bank B from Document A. However, due to the tracking of provenance information in transactions, such modification can be identified.

In practice, a transaction that includes Document A typically references a previous transaction and/or object. For example, as shown in FIG. 7b, the transaction that references Document A may also reference a good (Good A), which good is being used as collateral for the load. This good typically has a serial number (e.g. if the collateral is a car, the car will be associated with a VIN number). Therefore, the re-use of the collateral can be determined by an interrogation of the dependencies of a transaction.

A user that attempts a fraud, such as referring to a different VIN number in the document sent to Bank B, can be determined using other methods. For example, the bank is likely to check that any VIN number mentioned in a document is a real VIN number and is associated with User A. The identification that a user or an object is involved in a suspicious transaction (e.g. because the user has faked a VIN number) can be used to investigate any related transactions. Continuing with this example, if User A is found to have faked a VIN number, then each transaction that User A has been involved in can be determined by querying the blockchain and these transactions can be flagged for further investigation. This disincentivises any dishonesty by User A.

The querying of the blockchain and the investigation of transactions recorded on the blockchain is typically carried out by a computer device, which computer device may be arranged to receive information being uploaded to the blockchain. In particular the computer device may be arranged to receive and analyse the transactions being proposed for addition to the blockchain. Therefore, the computer device can identify suspicious transactions as they occur. These transactions can then be flagged for further review while, optionally, still being added to the blockchain.

In some embodiments, the computer device is arranged to determine a score for one or more objects, containing sets, or users of the blockchain. This score is typically dependent on:
One or more dependencies of the object, containing set, and/or user. In particular, objects are typically referenced in combination; for example, a document may be used to confirm the transfer of a good between users. The score for an object, containing set, and/or user may be dependent on a number of dependencies and/or a score associated with a linked object, containing set, and/or user. Therefore, an object that is linked to a number of other objects is likely to have a higher score than an object with fewer links (since each link is typically associated with verification of the object by another party).
   In practice, an object that has just been added to the blockchain by a user (and so has no dependencies) will typically have a low score. As this object gains dependencies, the score rises since these dependencies typically link the object to trusted information. Similarly, an object that is added to the blockchain by a new user will typically have a low score, an object that is added by an older/more trustworthy user will typically have a higher score due to an association with/dependency on this trustworthy user.
   Using the example of a car that has been given above, if a good associated with the car is uploaded to the blockchain without any dependencies this good will have a low score. If instead, a good is formed from a combination of a good associated with an engine and a good associated with a chassis, this formed good is likely to have a higher score, since the dependency on the engine and chassis can be used to identify the origin of the car.
An amount of provenance information available for the object, containing set, and/or user. Where an object, containing set, and/or user is added to the blockchain with only a small amount of provenance information this object, containing set, and/or user may be given a low score. As more provenance information becomes available (e.g. a reason for an object being uploaded and/or a way in which the object was created), the score may rise or fall depending on the nature of the provenance information. This provenance information may be provided by a user, or may be inferred based on connections to similar goods. Typically, the amount of provenance information available increases as the object, containing set, and/or user is involved in transactions on the blockchain, e.g. as more users are involved in the use of an object. An object that is claimed by a single user is likely to have a low score; an object that has been transferred between multiple users (and verified by each user) is likely to have a higher score.

The score can be used by the computer to identify suspicious objects and transactions (and to flag these objects/transactions for further investigation). In particular, objects, containing sets, and users with a score below a threshold may be identified as suspicious.

The scores of each object, containing set, and/or user is typically updated as time passes (e.g. the score may be updated each time a block is added to the blockchain). As mentioned above, the score for an object, containing set, and/or user typically changes as it is used and as relevant provenance information becomes available. Therefore, transactions that have been flagged as suspicious may be constantly monitored and updated (and potentially the flag may be removed). Equally, transactions that have not been flagged may be flagged if a user involved in these transactions is found to be untrustworthy.

Typically, instead of storing objects in their entirety, the blockchain maintains a record of hashes of these objects. The full objects may then be stored in a separate database. For example, a hash of a signed contract may be stored on the blockchain, where this hash is updated as the instance of the contract is incremented. The contract itself may be stored on a separate database, where any changes to this contract can be detected since these changes will affect the hash of the document. This precludes the need to store large documents on the blockchain while providing a straightforward method to detect forgeries (by detecting a mismatch between hashes). The hash of a document may be dependent on the document itself as well as one or more parties associated with the document (e.g. the hash may depend on the cryptographic keys of the signatories to the document).

### Alternatives and Modifications

Various other modifications will be apparent to those skilled in the art for example, for example, while the majority of the detailed description has considered the described digital currency being converted to and/or from a fiat currency, this digital currency could also be converted to and/or from another digital currency, or other asset.

It will be understood that the present invention has been described above purely by way of example, and modifications of detail can be made within the scope of the invention. For example, while the detailed description has primarily described methods and systems with reference to blockchain, the disclosures herein are more generally applicable to any distributed ledger technology and/or public consensus network. Reference numerals appearing in the claims are by way of illustration only and shall have no limiting effect on the scope of the claims.

1. A computer-implemented method of transmitting information from a first node of a blockchain to a second node of the blockchain, the method being carried out by the first node and comprising:
receiving a transaction referencing an object and a containing set of the blockchain;
determining an existing instance of each of the object and the containing set;
updating the existing instance of each of the object and the containing set; and
transmitting to the second node of the blockchain the updated instance of each of the object and the containing set.

2. The method of claim 1, wherein:
the object and the containing set are each associated with a persistent identifier that is recorded on the blockchain; and
determining the existing instance comprises determining a most recent instance associated with the persistent identifier from a record stored on the blockchain.

3. (canceled)

4. The method of claim 1, wherein the transaction referencing the object comprises the transaction referencing an identifier of the object and/or a persistent identifier of the object.

5. (canceled)

6. The method of claim 1, comprising:
identifying a second containing set of the blockchain;
updating an existing instance of each of the first containing set, the second containing set, and the object; and
transmitting to the second node of the blockchain the instance of each of the first containing set, the second containing set, and the object.

7. The method of claim 1, wherein updating an instance comprises incrementing the instance.

8. The method of claim 1, wherein the object and the containing set are each associated with a persistent identifier that is recorded on the blockchain, wherein the transaction referencing the object and/or the containing set comprises the transaction referencing a persistent identifier of the object and/or a persistent identifier of the containing set.

9. The method of claim 1, wherein the object and the containing set are each associated with an ephemeral identifier that is recorded on the blockchain, wherein the transaction referencing the object and/or the containing set comprises the transaction referencing an ephemeral identifier of the object and/or an ephemeral identifier of the containing set.

10. (canceled)

11. The method of claim 1, comprising transmitting to the second node two or more of:
a persistent identifier relating to the object and/or the containing set;
an ephemeral identifier relating to the object and/or the containing set;
an ephemeral identifier relating to the object and/or the containing set before completion and/or recording of the transaction; and
an ephemeral identifier relating to the object and/or the containing set after completion and/or recording of the transaction.

12. (canceled)

13. The method of claim 1, wherein:
the object comprises a coin; the containing set and/or a/the second containing set comprises a wallet; and/or, the method comprises: transferring the coin from a first wallet associated with a first party to a second wallet associated with a second party; or transferring the coin from the second wallet to the first wallet; and/or
the object comprises a document; the containing set and/or a/the second containing set comprises a document pool; and/or transferring the document from a first document pool associated with a first party to a second document pool associated with a second party; or transferring the document from the second document pool to the first document pool; and/or
the object comprises a good; the containing set and/or a/the second containing set comprises an inventory; and/or the method comprises transferring a good from a first inventory associated with a first party to a second inventory associated with a second party; or transferring the good from the second inventory to the first inventory; and/or
the object comprises a person; the containing set and/or a/the second containing set comprises a team; and/or; the method comprises transferring a person from a first team associated with a first party to a second team associated with a second party; or transferring the person from the second team to the first team.

14. (canceled)

15. The method of claim 1, comprising identifying a further object, wherein the transaction is dependent on, and/or references, both the object and the further object.

16. The method of claim 15, comprising determining a further containing set associated with the further object and a first party, wherein the containing set and the further containing set are associated with the same blockchain address and/or cryptographic key.

17. The method of claim 16, comprising:
identifying a plurality of objects associated with a/the transaction, the plurality of objects comprising at least two of the object types: a coin; a document; and a good; and/or
identifying a plurality of containing sets associated with a/the transaction, the plurality of containing sets comprising at least two of the containing sets types: a wallet; a document pool; and an inventory.

18. (canceled)

19. The method of claim 1, comprising determining provenance information associated with the transaction; and associating the provenance information with one or more of: the object, the first containing set, and/or a/the second containing set.

20. (canceled)

21. The method of claim 19, wherein the provenance information comprises one or more of: a reason for the transaction; an assessment of a/the sender and/or a/the recipient, such as an indication of a trust level; and information added by a third party following the transaction.

22. The method of claim 19, comprising receiving a confirmation from a third party, the confirmation being associated with the provenance information, wherein the confirmation verifies and/or provides the provenance information, and validating and/or propagating a transaction in dependence on the confirmation.

23-24. (canceled)

25. The method of claim 1, comprising determining a score associated with the object and/or the containing set and providing an alert if the score is below a threshold score.

26. The method of claim 1, comprising determining a plurality of instances of the object recorded on the blockchain, and determining an order of the instances, wherein the order is dependent on the transactions in which the object has been referenced, the method further comprising:
transmitting export data to a node of the blockchain, which export data relates to the object and comprises an indication of the earlier instance.

27. The method of claim 1, comprising:
determining a version of an interpreter associated with the blockchain at the time of receipt of the transaction; and
transmitting an indicator of the version to the second node.

28-30. (canceled)

31. An apparatus arranged to store, access, view, and/or edit a blockchain comprising a transaction associated with an object and a first party, the transaction being associated with:
a containing set associated with the first party; and
wherein the transaction is associated with an update in the instance of each of the object and the containing set.

32-42. (canceled)

43. A computer device comprising a processor, the processor being arranged to perform a method comprising:
receiving a transaction referencing an object and a containing set of the blockchain;
determining an existing instance of each of the object and the containing set;
updating the existing instance of each of the object and the containing set; and
transmitting to the second node of the blockchain the updated instance of each of the object and the containing set.
